(19) United States
(12) Patent Application Publication
(10) Pub. No.: US 2003/0185368 A1
(43) Pub. Date: Oct. 2, 2003

(54) Methods and systems to install a network service

(75) Inventors: Terry Bradfield, Beaverton, OR (US); Jeff R. Jackson, Newberg, OR (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/112,546

(22) Filed: Mar. 28, 2002

(51) Int. Cl. H04M 3/42

(52) U.S. Cl. 379/201.03

(57) ABSTRACT

Computing devices in a network offer network services by transmitting and receiving network service packets. In one embodiment, the packet includes a network service rank and a network service code. Each computing device within the network receives a transmitted packet and validates the accompanying service code. If the service code is validated, the packet's accompanying offered network service's rank is evaluated against an existing network service's rank. If the offered network service's rank is greater than the existing network service's rank, then an existing network service is disabled, and the network service identified by the received packet is installed. Further, each computing device periodically transmits to the remaining computing devices a packet identifying the transmitting computing device's offered network service's rank and the transmitting computing device's service code.

### TECHNICAL FIELD

Embodiments of the present invention relate generally to installing a network service on a network and more specifically to automatically identifying and installing a network service on a network.

BACKGROUND INFORMATION

In today's highly interconnected and electronic environments, it is becoming increasingly popular and desirable for electronic services within an electronic network to be shared and distributed among computing devices participating in the electronic network. By sharing electronic services, a single version of the service is maintained and supported by network administrators. Furthermore, processing associated with the shared electronic services can be distributed throughout the network to improve overall network performance. Moreover, licensing restrictions associated with the electronic services can be more easily monitored and enforced when the electronic services are shared within a network.

Yet, if network administrators do not appropriately monitor the types of available shared services operating within the network, the performance of the network can become degraded and often unreliable. For example, if a user installs a first network service (e.g., AnyPoint Internet Sharing Software (ISS) distributed by the Intel Corporation) to provide Internet connectivity to all computing devices within a peer-to-peer (P2P) network, and then later installs a different network service (e.g., a residential gateway service), the network performance can be adversely affected if the first network service (e.g., AnyPoint ISS) is not properly removed from the network before the second network service (e.g., residential gateway) is made available over the network. This is so, because the first network service (e.g., AnyPoint ISS) and the second network service (e.g., residential gateway) are providing similar services and correspondingly using and accessing similar network resources (e.g., communication ports, memory addresses, and the like). Therefore, unless the first network service (e.g., AnyPoint ISS) is uninstalled from the network, access to the Internet can become degraded within the network and in some cases unreliable within the network.

Conventionally, a network administrator manually installs a new network service on a network using installation instructions and installation software associated with the new network service. Typically, the installation software detects the existence of network services that are already operating within the network and which can cause problems for the network if the desired network service is installed when these existing network services remain operational within the network. Accordingly, the installation software notifies the network administrator of the potential conflict and suggests that the conflicting network services be uninstalled from the network before proceeding with installation of the desired network service.

In some instances, the network administrator ignores the warning provided by the installation software in order to rapidly proceed with installation of the desired service. This results in reduced network performance and increased network reliability problems occurring within the network. Reliability problems, occurring within the network may not be easily detected by the network administrator or by any system analyst evaluating the reliability problems.

Accordingly, the network and/or any network services affected by the reliability problems can be offline, unreliable, and unavailable for extended periods of time until the often-obscure problem is detected and any associated network services uninstalled/disabled from the network. Moreover, even after the problematic network services are uninstalled/disabled from the network, the desired network service will often still have to be uninstalled from the network and then reinstalled on the network in order to ensure proper operation of the network and the desired network service. As one of ordinary skill in the art readily appreciates, the entire network service installation process and problem detection process are largely manual techniques that are fraught with a myriad of potentially dire network consequences.

Moreover, during a network installation process that provides new network services to a user, the user, who is currently accessing any affected network service, will typically have his/her network access interrupted or abruptly terminated. As a result, network administrators utilize elaborate and often inconvenient notification techniques to properly prepare users for any incipient installation process. For example, a network administrator may use a network broadcast message sent across the network to alert all users that they must log off the network or exit certain network services in order to accommodate a pending installation for a new network service.

But, some users may not be actively viewing their display monitors when the broadcast message is sent, and correspondingly these users will not be notified of the broadcast message. Furthermore, some network administrators will schedule network installations for network services, such that the installations occur at times when users are not likely to be logged into the network or using any network services. However, this technique requires network administrators to install network services at inconvenient times during the day or on inconvenient days during the week. As a result, any work schedules associated with affected groups and/or network administrators within an organization are adversely affected by existing network installation techniques.

Accordingly, current network service installation techniques are not flexible enough, since existing techniques require a substantial amount of manual intervention and a substantial amount of manual attention by network administrators. Moreover, even slight mistakes, which may occur during a network service installation, can result in catastrophic network problems, which can persist for extended periods of time until properly detected and resolved. Therefore, there exists a need for improved automatic network installation techniques in order to reduce the problems associated with conventional techniques by alleviating the manual dependencies and interactions associated with conventional network service installation techniques.

### BRIEF DESCRIPTION OF THE DRAWINGS

FIG. 1 is a flow diagram of a method to install a network service, in accordance with one embodiment of the invention.

FIG. 2 is a flow diagram of another method to install a network service, in accordance with one embodiment of the invention.

FIG. 3 is a flow diagram of still another method to install a network service, in accordance with one embodiment of the invention.

FIG. 4 is a diagram of example data structures used to install a network service, in accordance with one embodiment of the invention.

FIG. 5 is a diagram of a network installation system, in accordance with one embodiment of the invention.

FIG. 6 is a flow diagram of network installation processes, in accordance with one embodiment of the invention.

### DESCRIPTION OF THE EMBODIMENTS

Novel network service installation techniques are described. In the following detailed description of the embodiments, reference is made to the accompanying drawings, which form a part hereof, and in which is shown by way of illustration, but not limitation, specific embodiments of the invention that may be practiced. These embodiments are described in sufficient detail to enable one of ordinary skill in the art to understand and implement them, and it is to be understood that other embodiments may be utilized and that structural, logical and electrical changes may be made without departing from the spirit and scope of the present disclosure. The following detailed description is, therefore, not to be taken in a limiting sense, and the scope of the embodiments of the inventions disclosed herein is defined only by the appended claims.

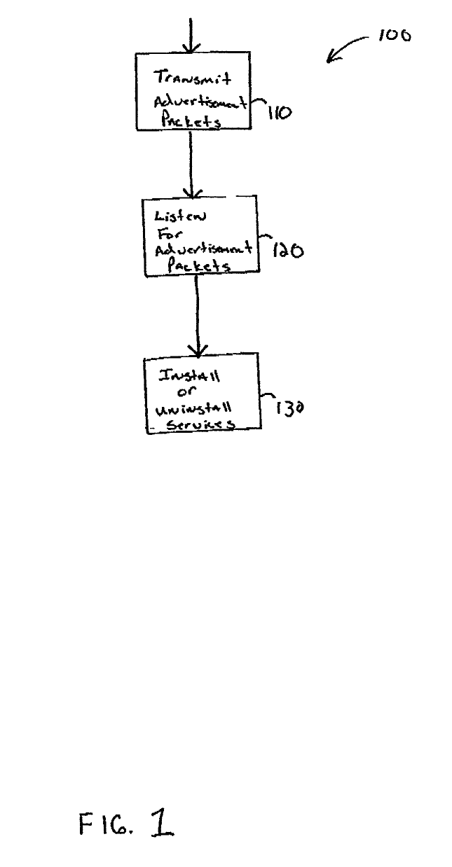

FIG. 1 is a flow diagram for one method 100 to install a network service, in accordance with one embodiment of the invention. Initially, device drivers and protocols associated with network services operating on one or more computing devices within a network are modified to inspect and transmit advertisement packets. In some embodiments, the advertisement packet is a small data packet that includes a network service code identifying the type of device offering the network service and the type of network service being offered. Moreover, the data packet includes a network service ranking for the offered network service. In one embodiment, the rank is an integer number representing a priority of use associated with the network service as compared to other network services providing the same or similar services as the offered network service. In some instances, the network service rank can be provided with an existing service or can be provided and modified by a network administrator or a user. Of course as one of ordinary skill in the art will readily appreciate, the network service rank need not be an integer, as any floating-point representation, or character string, is sufficient for the various embodiments of the present disclosure.

Each computing device within the network for each offered and unique network service constructs the data packet. Moreover, the data packet can include a variety of additional information such as, and by way of example only, packet header information used to inspect and parse the contents of a received packet by a receiving computing device, service information, vendor information, language character set information, and the like. Accordingly, advertisement packets are periodically constructed and transmitted in 110 via a broadcast to all the remaining computing devices within the network.

In some embodiments, the broadcast occurs using User Datagram Protocol (UDP) to all computing devices within the network. Of course any communication protocol can be used to broadcast the data packet throughout the network such as, and by way of example only, Transmission Control Protocol (TCP), and others. Moreover, UDP can be combined with Internet Protocol (IP) to provide UDP/IP communications; similarly TCP can be combined with IP to provide communications in TCP/IP. As is readily apparent to one of ordinary skill in the art, if the constructed data packet is small in byte size, using UDP or UDP/IP communications can improve processing throughput of the data packet, since UDP will not divide the data packet into smaller sequenced datagrams. Conversely, if a data packet is larger in byte size, TCP or TCP/IP communications can improve reliability of the data packet broadcast and subsequent processing, since TCP will divide the data packet into smaller sequenced datagrams, which can later be assembled and verified by a receiving and processing computing device.

The period used to broadcast the data packet from each computing device throughout the network is a configurable period. In one embodiment, the period defaults to ninety seconds and continues until the broadcasting operation for any particular network service is terminated. Termination of broadcasting for a particular service can occur automatically when it is determined that a higher ranking network service is already in operation within the network than an offered network service represented by a particular constructed data packet. In other embodiments, a network administrator can manually terminate the broadcasting of a particular data packet.

In 120, each computing device within the network is operable to manually listen for and detect any broadcast advertisement packets. In one embodiment, each computing device detects a received data packet by periodically scanning a defined communications port associated with the listening computing device. Furthermore, in some embodiments the communications port can be specifically registered and reserved for the exclusive use of receiving and detecting broadcasted advertisement packets (e.g., port number 3346).

When a listening computing device detects a received data packet, the data packet is parsed to detect a received network service code and a received network service rank. In some embodiments, the data packet is a predefined fielded packet where each fielded entry, included within the data packet, is readily parsed and identified by the receiving computing device by having advanced knowledge of the predefined fields and the byte lengths associated with each field. In other embodiments, the data packet is tagged with a markup language such as extensible markup language (XML), hypertext markup language (HTML), standard generalized markup language (SGML), portable document format (PDF), and others. In these embodiments, standard parsing applications and services are used to parse and extract the received network service code and the received network service rank.

Moreover, in some embodiments the entire data packet can be encrypted and/or signed such that the receiving computing device can validate and certify the received data packet. Any public key infrastructure (PKI) encryption technique (e.g., public-private key pairs) can be used to encrypt and/or digitally sign the data packets from a transmitting computing device within the network and subsequently decrypt and verify the advertisement packets by any receiving computing device. Further, ad hoc encryption techniques can be used to encrypt and decrypt the data packet.

In one embodiment, if the received network service code is not identified with a list of acceptable service codes maintained and accessible to a receiving computing device, then the entire received data packet is ignored. For example, a service code for a computing device associated with a computing peripheral device interfaced to the network may not be permitted to offer network services within the network. Moreover, the service code can be used to authenticate only authorized computing devices within the network that can offer network services. In this way, unwanted and undesirable proliferation of viruses can be minimized by adding security associated with only valid service codes.

In 130, if a received network service rank for an offered network service is greater than an existing network service rank operating on a computing device receiving the data packet, then an existing network service is uninstalled or otherwise terminated, and the offered network service is installed. As one of ordinary skill in the art will readily appreciate, this entire process can be automatic, since the receiving computing device can automatically activate one or more software applications associated with the existing network service to terminate its operation, and subsequently initiate one or more software installation applications to install the offered network service, which is identified in the received data packet.

However, if the received network service rank is less than the existing network service rank the receiving computing device immediately constructs an advertisement data packet for the existing network service and sends a unicast communication directly to the computing device that broadcast the received network service rank. Once the broadcasting-computing device that sent the received network service rank, receives the advertisement packet associated with the existing network service and inspects the advertisement packet, the offered network service is withdrawn from the broadcasting computing device, and the existing network service is installed on the broadcasting-computing device. All communications occurring among computing devices within the network are automatic requiring no manual intervention. Accordingly, higher ranking network services are automatically communicated and installed to the network, and existing network services that can collide or cause reliability problems for the network are automatically disabled and uninstalled.

If the received network service rank is identical to the existing network service rank, then any suitable heuristic installed by a network administrator can be executed to resolve whether the offered network service is installed to the network or whether the existing network service will remain operational within the network. For example, a descriptive name associated with the network services can be compared and then used to select a desired network service based on alphabetic ordering of the descriptive names. Further, any ad hoc heuristic, including any suitable logic implemented by a network administrator, can be deployed to resolve installation conflicts, and all such heuristics and logic are intended to fall within the various embodiments of the disclosure.

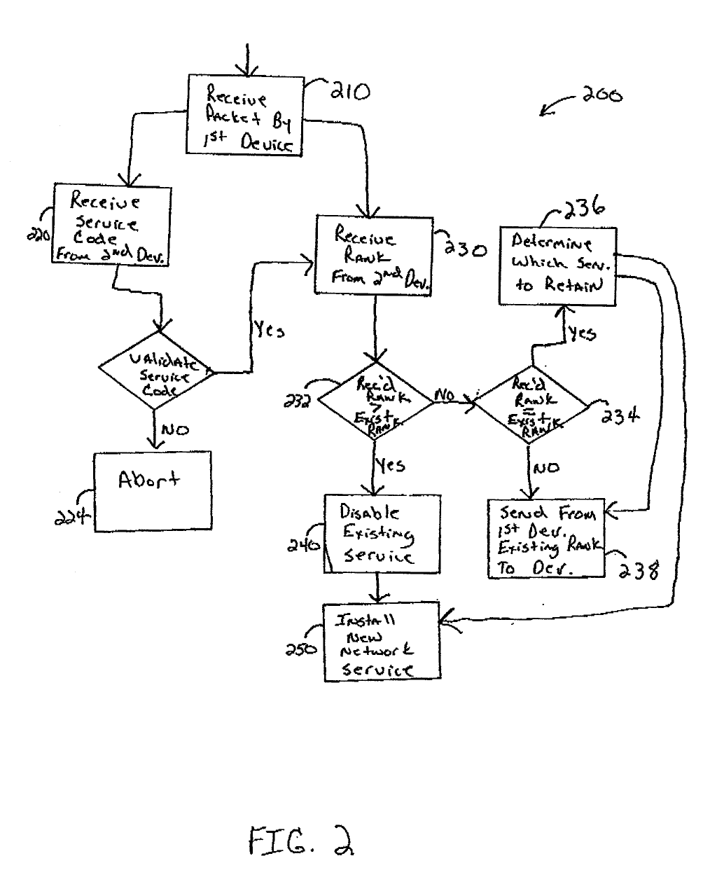

FIG. 2 is a flow diagram of another method 200 to install a network service, in accordance with one embodiment of the invention. In one embodiment a data packet is received from a first computing device in 210. The data packet, in some embodiments, is represented as a fielded data structure or a tagged data structure. In one embodiment, the data structure is parsed to acquire a network service code as depicted in 220. The network service code identifies a type of second computing device sending the data packet and/or a type of an offered network service being offered for use on a network. The first computing device is interfaced via a network to a second computing device and optionally a plurality of additional computing devices.

In one embodiment, the network service code is validated in 222 to ensure that the second computing device is authorized to offer a network service for installation on the first computing device and the network. The network service code can be validated against a list of authorized network service codes maintained and accessible to the first computing device. Furthermore, in some embodiments the network service code provides authentication or verification of authorized offered services and/or authorized second computing devices. If the network service code is not validated, then in 224 then the first computing device aborts parsing and inspecting the packet received from the second computing device. Moreover, in some embodiments the packet does not include a network service code.

In 230 the first computing device receives a network service rank. In one embodiment, the network service rank is included in the packet received from the second computing device. In other embodiments, the first computing device receives only the network service rank from the second computing device, and the network service rank can be sent directly as a data message or embodied within the data packet. Communication between the first and second computing devices can occur using UDP, UDP/IP, TCP, TCP/IP, or any other readily available data message communication protocol. Furthermore, in one embodiment a registered and exclusively used communication port of the first computing device is operable to receive the data packet and/or the network service rank.

The first computing device periodically listens for or otherwise detects the received data packet and/or network service rank. The period of time can be configured on the first computing device (e.g., every 90 seconds). Alternatively, the detection of the received data packet and/or network service rank is event-driven such that automatic events are raised on the first computing device when a received data packet and/or network service rank is received on the first computing device.

If the received network service rank is greater than an existing network service rank associated with an existing network service in 232, then the existing network service is disabled in 240. In some embodiments, the existing network service is uninstalled from the first computing device entirely, or alternatively if the existing network service does not collide with the offered network service, the existing network service is halted or terminated. Moreover, in 250 the offered (e.g., new) network service is installed and initiated on the first computing device and correspondingly on the network as a whole.

But, if the received network service rank is not greater than the existing network service rank, a further inspection is made in 234 to determine if the received network service rank is equal to the existing network service rank. If the compared network service ranks are equal, then in 236 a determination is made as to which network service to retain and use on the first computing device and correspondingly on the network. Any suitable, predefined heuristics or logic to resolve conflicts between network services having the same network service ranks can be used in 236 to make a determination.

In 238 if the received network service rank is less than the existing network service rank, then the first computing devices ignores the offered network service received from the second computing device and immediately sends directly to the second computing device the existing network service rank. Upon receipt of a higher existing network service rank, the second computing device disables or otherwise uninstalls the offered network service, if the offered network service had been operational on the second computing device, and the second computing device installs the existing network service on the second computing device.

As one of ordinary skill in the art readily appreciates, the communications between the first and second computing devices are entirely automated using the transfer of data messages between the two computing devices on the network. The data messages can comprise data packets including network service codes and network service ranks, or alternatively the data messages can be only network service ranks. Moreover, in some embodiments a plurality of additional computing devices participate in the processing and transmission of the data messages. Further, in one embodiment the processing of the received data messages occurs within a device driving set of executable instructions residing on each of the computing devices within the network. Additionally, the network service can be any set of executable instructions shared or distributed among the computing devices on the network. For example, in one embodiment the network service provides a protocol service to permit computing devices within the network to share a single Internet connection (e.g., AnyPoint ISS, residential Internet gateway, and others).

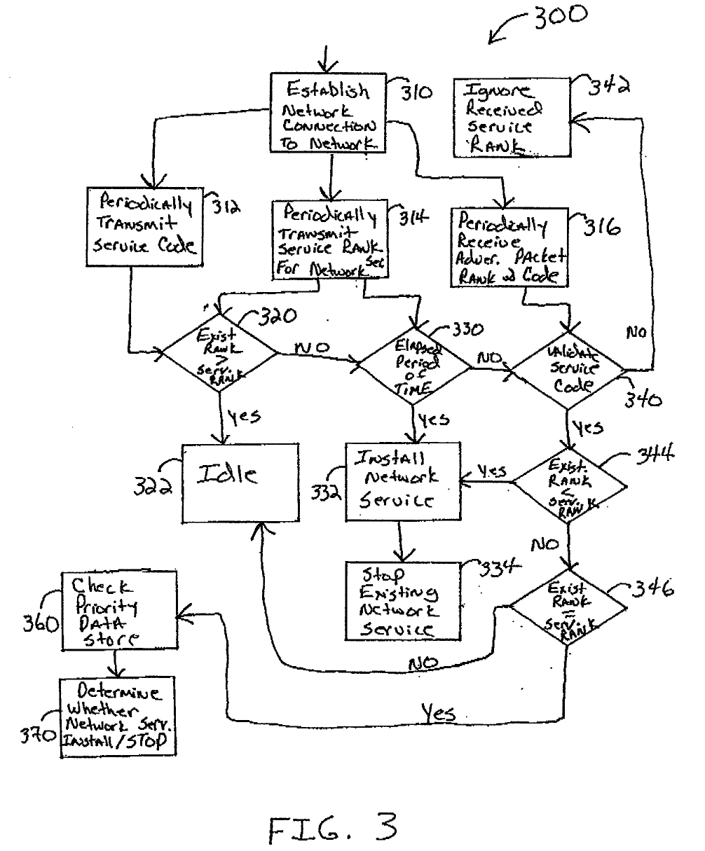

FIG. 3 is a flow diagram of still another method 300 to install a network service, in accordance with one embodiment of the invention. Initially, a network connection is established in 310 with an existing network interface having a plurality of computing devices in communication with one another. The network connection can be hardwired, wireless, or combination thereof. Moreover, the network interface can use any widely available network protocol interface for communication among the computing devices within the network.

Next, in one embodiment each computing device periodically transmits in 312 an advertised network service code via a broadcast data message to each of the remaining computing devices within the network. The broadcast can occur using UDP, UDP/IP, TCP, TCP/IP, or any other data message network communication protocol. The advertised network service code can be included within a network advertisement data packet that also includes an advertised network service rank. The advertised network service code identifies a type of computing device transmitting the advertised service code or a type of offered/advertised network service represented by the advertised network service code.

The advertisement data packet can be a fielded data message where each field of the data message is readily parsed and identified by a receiving computing device by having prior knowledge of the predefined starting locations for each field within the data packet along with each field's length in bytes. Alternatively, the advertisement data packet can be a tagged data message where each field of the data message is readily parsed and identified using existing parsing utilities for tagged data formats such as and by way of example only, XML, HTML, SGML, PDF, and the like.

In 314 each computing device within the network periodically transmits an advertisement network service rank via a broadcast data message to the remaining computing devices within the network. In some embodiments, the transmitted advertisement network service ranks are also included within the advertisement data packet and accompanied by the appropriate advertised network service codes. The periods of transmissions for the advertisement data packets are configurable within the network.

Moreover, each computing device also periodically receives and listens for advertised network service ranks and/or advertisement data packets being transmitted by the remaining computing devices within the network in 316, such that if an existing network service rank identified with an operational and existing network service is greater than a received advertised network service rank in 320, then the listening process idles in 322, since no action needs to be taken by the listening computing device.

Furthermore, if a transmitting computing device broadcasts an advertised network service rank throughout the network and receives no subsequent higher network service rank from any of the remaining computing devices within a configurable period of elapsed time in 330, then, in some embodiments, the transmitted advertised network service rank is presumed to be greater than the existing network service rank, and in 332 the network service associated with the transmitted advertised network service rank is installed on the transmitting computing device, with the existing network service stopped, halted, or uninstalled in 334.

When an advertised network service rank or advertisement data packet is detected and received by a receiving computing device within the network, the advertised service code, if present, is validated in 340. Validation can occur by authenticating and/or decrypting the advertised network service code using any suitable PKI techniques or encryption/decryption techniques. Alternatively, validation occurs when the receiving computing device checks the received advertised service code against a list of acceptable and authorized service codes for the offered service. If the advertised service code is not validated, then the received advertisement packet and received advertised network service rank are ignored in 342.

If an advertised network service code is validated, then the existing network service rank is compared against the received advertised network service rank in 344. Thus, if the existing network service rank is less than the received advertised network service rank, the offered network service is installed in 332 on the receiving computing device, and the existing network service is stopped, halted, or uninstalled from the receiving computing device in 334. Of course as one of ordinary skill in the art appreciates, there is no requirement in some embodiments that an advertised network service code be received, and in these embodiments validation of the advertised network service code is bypassed, and the advertised network service rank is immediately compared against the existing network service rank.

If the existing network service rank is equal to the received advertised network service rank in 346, then in 360 the receiving computing device checks a priority data store to determine in 370 whether the offered network service represented by the advertised network service rank should be ignored or installed on the receiving computing device. But, the receiving computing device idles in 322 if the existing network service rank is not equal to the received advertised network service rank, and the receiving computing device waits for another received advertisement data packet or advertised network service.

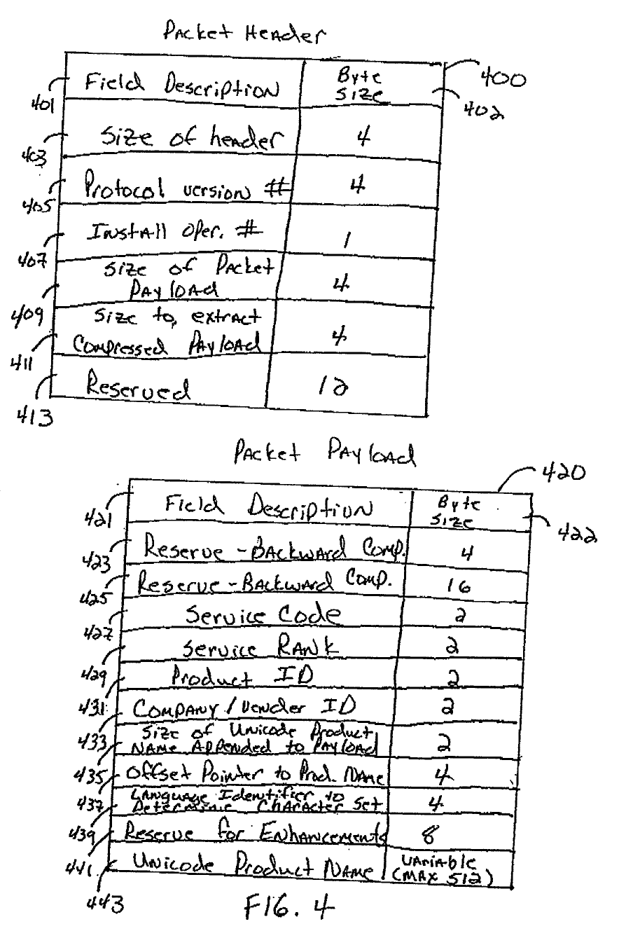

FIG. 4 is a diagram of example data structures 400 and 420 used to install a network service, in accordance with one embodiment of the invention. FIG. 4 is an example of data structure 400 and 420 for one embodiment of the disclosure used to automatically install an offered network service on one or more computing devices interfaced in a network. The data structures 400 and 420 include a packet header data structure 400 and a packet payload data structure 420.

A receiving computing device within the network parses and acquires information included within the appended packet payload data structure 420 by using the packet header data structure 400. FIG. 4, for purposes of illustration only, represents the data structures 400 and 420 as fielded data structures 400 and 420, although this is not a requirement with the various embodiments of the disclosure, since as one of ordinary skill in the art appreciates the data structures 400 and 420 could just as readily be represented as tagged data structures 400 and 420 using a data markup language such as, and by way of example only, XML, HTML, SGML, PDF, and the like.

The data structures 400 and 420 are periodically broadcast by each computing device within the network using any network communication protocol such as, and by way of example only, UDP, UDP/IP, TCP, TCP/IP, and the like. Moreover, the data structures 400 and 420 are periodically detected as being received from one or more computing devices within the network on one or more defined communication ports or defined file directories accessible to any receiving computing device. Once the data structures 400 and 420 are received, they are parsed, and the information included within the data structures 400 and 420 is processed in accordance with the teachings of the disclosure.

In one embodiment, the packet header data structure 400 precedes the packet payload data structure 420 and includes a variety of information having two attributes, namely a field description attribute 401 and a field byte size length attribute 402. In some embodiments, the fields include a size of packet header description 403 having a byte size of 4, a communication protocol versioning number 405 having a byte size of 4, an installation operation number 407 having a byte size length of 1, a size of packet payload description 409 having a byte size length of 4, a byte size necessary to extract a compressed and/or encrypted payload description 411 having a byte size length of 4, and a reserved for future use description 413 having a byte size length of 12.

Moreover, in one embodiment the packet payload data structure 420 is appended to the packet header data structure 400 and includes a variety of information having two attributes, namely a field description 421 and a field byte size length attribute 422. In some embodiments, the fields include two reserved for backward compatibility descriptions 423 and 425 having byte size lengths of 4 and 16, a network service code 427 having a byte length of 2, a network service rank 429 having a byte size length of 2, a network service product identifier 431 having a byte size length of 2, a company or vendor identifier 433 having a byte size length of 2, a size of Unicode product name appended to the payload descriptor 435 having a byte size length of 2, an offset pointer to the network service product name 437 having a byte size length of 4, a language identifier to determine the character set for displaying the network service product name 439 having a byte size length of 4, a reserved for enhancements description 441 having a byte size length of 8, and a Unicode product name description 443 having a variable byte size length up to a maximum of 512 bytes.

FIG. 4 provides one example implementation of a flexible data packet according to one embodiment of the disclosure. It is provided for purposes of illustration only, and it is readily apparent that the exact configuration of FIG. 4 is not required with various other embodiments of the disclosure. In fact, in some embodiments a data packet is not required at all, since all that is minimally required is a network service rank, and in some other embodiments a network service code is used in combination with the network service rank. Moreover, a variety of additional information can be included in FIG. 4; all such additional information is intended to fall within the scope of the various embodiments of the disclosure.

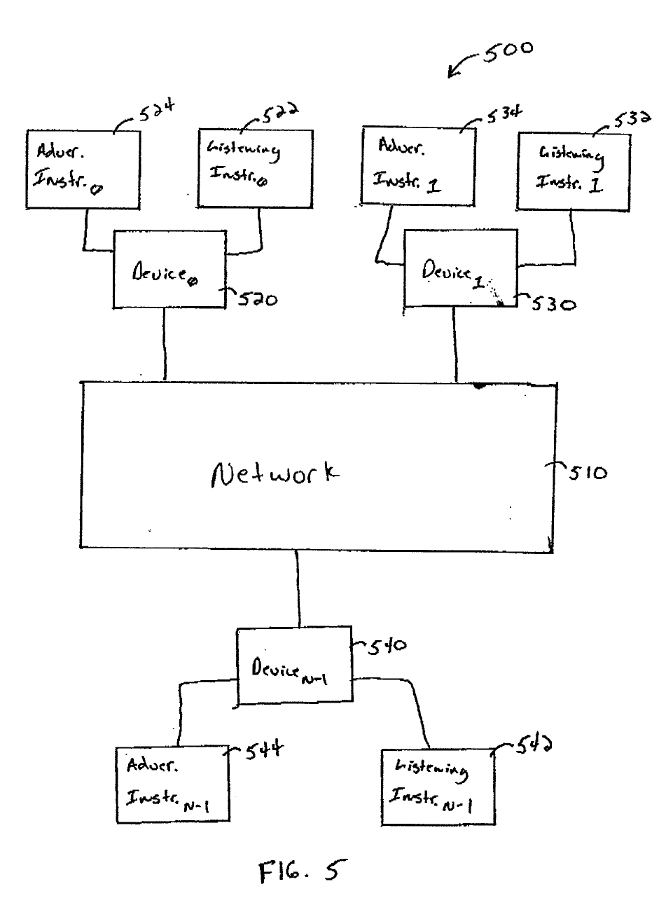

FIG. 5 is a diagram of one network installation system 500, in accordance with one embodiment of the invention. The network installation system 500 includes a network 510 a plurality of computing devices (e.g., 520, 530, and 540), a plurality of listening sets of executable instructions (LSEIs; e.g., 522, 532, and 542), and a plurality of advertising sets of executable instructions (ASEIs; e.g., 524, 534, and 544). Each computing device (e.g., 520, 530, or 540) includes a single LSEI and a single ASEI. And, in some embodiments, the LSEIs (e.g., 522, 532, and 542) are combined with the ASEIs (e.g., 524, 534, and 544) to form a single set of executable instructions.

Each LSEI (e.g., 522, 532, and 542) operates on a single computing device (e.g., 520, 530, and 540) and receives or otherwise detects an advertisement packet transmitted or broadcasted from the remaining computing devices (e.g., 520, 530, or 540). In some embodiments, detection is achieved by inspecting a registered and exclusive communication port associated with the computing devices (e.g., 520, 530, and 540) housing the LSEIs (e.g., 533, 532, and 542). In other embodiments, detection is achieved by the LSEIs (e.g., 533, 532, and 542) inspecting a predefined directory for a received advertisement packet. In still more embodiments, detection is event-driven such that when an advertisement packet is received, an event is raised automatically within the LSEIs (e.g., 533, 532, and 542).

In one embodiment, the advertisement packets include network service codes identifying types of computing devices broadcasting the advertisement packets and/or types of offered network services represented by the network service codes. Moreover, the advertisement packets include network service ranks associated with priorities of operation and installation for offered network services. The LSEIs (e.g., 522, 532, and 542) inspect detected and received advertisement packets to acquire network service codes, if applicable, and network service ranks. If a network service code is present in any received advertisement packet, then the service code must be validated or authorized before any inspection of the associated network service rank proceeds.

If a detected network service rank is greater than an existing network service rank associated with an existing and operational network service, then the existing network service is removed from the network 510, and the offered network service is installed to the network 510, if the offered network service is not already installed and operational within the network 510. However, if a detected network service rank is less than the existing network service rank, then, in some embodiments, the LSEI (e.g., 522, 532, or 542) immediately transmits directly to a sending computing device (e.g., 520, 530, or 540) associated with broadcasting the offered network service, the existing network service rank. In this way, the sending computing device (e.g., 520, 530, or 540), receives immediate notification that the offered network service is of a lower priority then the existing network service, allowing the sending computing device to immediately install and use the existing network service operational within the network 510.

Furthermore, in one embodiment, each LSEI (e.g., 522, 532, or 542) interfaces with a duplicate service set of executable instructions when the received and detected network service rank is equal to the existing network service rank. The duplicate service set of executable instructions resolves conflicts and makes an appropriate determination as to whether the offered network service is installed to the network 510 or the offered network service is ignored and the existing network service remains operational within the network 510.

Each ASEI (e.g., 524, 534, and 544) operates on a single computing device (e.g., 520, 530, and 540) within the network 510 and transmits or otherwise broadcasts to the remaining computing devices (e.g., 520, 530, or 540) advertisement packets associated with offered network services. The broadcasts occur, in some embodiments, at configurable periods within the network 510. Moreover, broadcasts can be terminated when the ASEI (e.g., 524, 534, or 544) receives notification that the offered network service is of lower priority than the existing network service operational within the network 510.

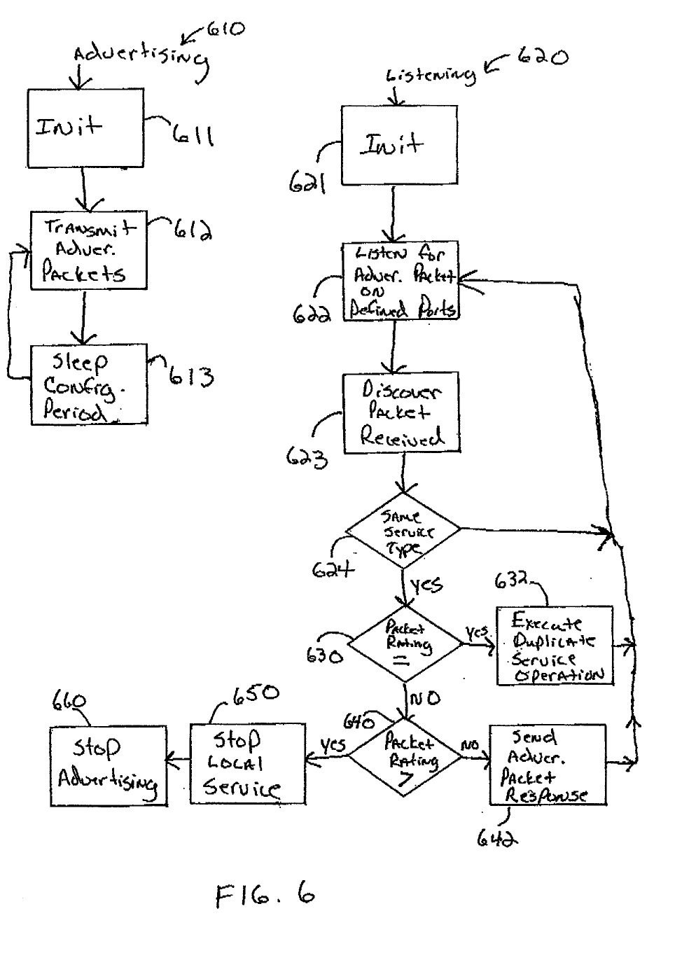

FIG. 6 is a flow diagram of network installation processes 610 and 620, in accordance with one embodiment of the invention. In this embodiment, process 610 is an advertising process, and process 620 is a listening process. In some embodiments, the processes 610 and 620 are threaded and logically separated from one another. In other embodiments, the processes 610 and 620 are not threaded and can be combined with one another. Each process (e.g., 610 and 620) is operational on a single computing device included within a network configuration having a plurality of computing devices.

The advertising process 610 begins in 611 by performing initialization. As one of ordinary skill in the art readily appreciates, initialization can include initializing data structures that are to be broadcast by the advertising process 610, identifying broadcasting communication protocols, identifying offered network services, identifying network service codes, identifying network service ranks, and the like. Accordingly, after initialization advertisement packets are constructed, and in 612 the packets are transmitted or broadcasted throughout the network to the remaining computing devices. After transmitting the advertisement packets, the advertising process 610 sleeps or idles for a configurable period of time in 613.

The listening process 620 also begins with initialization in 621. In one embodiment initialization includes identifying the communication port or file directory where received advertisement packets will be detected, identifying a configurable period during which a check is to be made as to whether an advertisement packet is received, identifying all existing network services operational within the network, identifying all authorized service codes, identifying all network service ranks associated with operational network services within the network, and the like.

In 622, the listening process 620 waits and listens for a received advertisement packer on a defined communication port until in 623 an advertisement packet is discovered. Next in 624, the service type or code identified in the discovered advertisement packet is checked against an existing service code to determine if the discovered service code is of a type permissible to offer a network service to the network, and if the service code is not an authorized or valid type, then the listening process ignores the discovered advertisement packet and again listens for another advertisement packet in 622. However, if the service code is of a permissible type, then a discovered service rank or priority rating is checked against an existing network service rank or rating associated with an existing network service operational within the network and having the same or compatible service code. If the discovered network service rank or rating is equal to the existing network service rank or rating in 630, then in 632 a duplicate service operation is called to resolve the conflict.

If the discovered network service rank or rating is not equal to the existing network service rank or rating, then in 640 a check is made to determine if the discovered network service rank or rating is greater than the existing network service rank or rating. Accordingly, if the discovered network service rank or rating is not greater, then in 642 an advertisement packet associated with the existing network service is immediately unicast back to the originally broadcasting computing device associated with the discovered advertisement packet.

But, if the discovered network service rank or rating is greater than the existing network service rank or rating, then in 650 the local network service associated with the operation of the existing network service is stopped, halted, or uninstalled, and the offered network service is allowed to operate or is otherwise installed as the case may be. Moreover in 660, communicating this information to the advertising process 610 stops any advertisement packet associated with the existing network service from being further broadcast throughout the network.

One of ordinary skill in the art will understand, upon reading and comprehending this disclosure, the manner in which software instructions can be written and installed to execute on one or more processors in a computer-based system to perform the methods disclosed herein. One of ordinary skill in the art will further understand that various programming languages may be employed to create software instructions designed to implement and perform the methods and systems of the present disclosure. For example, the programs can be structured in an object-orientation using an object-oriented language such as Java, Smalltalk or C++, and the programs can be structured in a procedural-orientation using a procedural language such as COBOL, C, assembler, or micro-code. The software components communicate in any of a number of ways that are well known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). However, as will be appreciated by one of ordinary skill in the art upon reading this disclosure, the teachings of the present disclosure are not limited to a particular programming language or any particular programming environment.

It is to be understood that the above description is intended to be illustrative, and not restrictive. Many other embodiments will be apparent to those of skill in the art upon reviewing the above description. The scope of embodiments of the invention should, therefore, be determined with reference to the appended claims, along with the full scope of equivalents to which such claims are entitled.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Description of the Embodiments, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject mater lies in less than all features of a single disclosed embodiment. Thus the following claims are hereby incorporated into the Description of the Embodiments, with each claim standing on its own as a separate exemplary embodiment.

What is claimed is:

1. A method comprising:
receiving a rank by a first computing device sent from a second computing device, wherein the rank is associated with an offered network service;
checking the offered network service's rank against an existing network service's rank;
disabling an existing network service, if the offered network service's rank is greater than the existing network service's rank; and
installing the offered network service, if the rank is greater than the existing network service's rank.

2. The method of claim 1, further comprising sending from the first computing device the existing network service's rank to the second computing device, if the offered network service's rank is less than the existing network service's rank.

3. The method claim 1 wherein in receiving, the offered network service's rank is included in a packet, and wherein the packet also includes a network service code associated with a type of device for the second computing device.

4. The method of claim 3 further comprising validating the network service code before checking the offered network service's rank, and if the network service code is not validated, then aborting checking the offered network service's rank.

5. The method of claim 3 wherein in receiving, the packet is processed in a device driver set of executable instructions of the first computing device.

6. The method of claim 1 wherein in receiving, the offered network service provides a protocol to share Internet connectivity among a plurality of computing devices in a network, and wherein the plurality of computing devices includes the first computing device and the second computing device.

7. A method comprising:
transmitting a service rank of an offered network service to each of a plurality of computing devices within a network;
installing the offered network service when the service rank of the offered network service is greater than an existing service rank; and
removing the offered network service from the network when the existing service rank is greater than the service rank of the offered network service.

8. The method of claim 7, further comprising checking an existing service code associated with the existing service rank to ensure an offered service code, associated with the offered network service, is associated with an authorized computing device within the network before removing an existing network service and installing the offered network service.

9. The method of claim 7 wherein in transmitting, the service rank of the offered network service is included in a packet, and wherein the packet also includes a service code that identifies a type of computing device providing the offered network service within the network.

10. The method of claim 7 wherein in installing, the existing service rank is presumed to be less than the service rank of the offered network service if no existing service rank is received within a period of time after transmitting the service rank of the offered network service.

11. The method of claim 7 further comprising periodically receiving by one of the plurality of computing devices within the network an advertised service rank transmitted from a number of the remaining computing devices within the network, and if any received advertised service rank is greater than the existing service rank, an existing network service associated with the existing service rank is removed from the network.

12. The method of claim 11 wherein in periodically receiving, each advertised service rank is accompanied by an advertised service code associated with a type of computing device sending the advertised service rank, and wherein each received advertised service rank is ignored if the accompanying advertised service code is unauthorized.

13. The method of claim 7 further comprising periodically retransmitting the service rank of the offered network service to each of the computing devices within the network.

14. The method of claim 7 further comprising checking a priority data store to determine whether to install the offered network service or remove the offered network service from the network when the service rank of the offered network service is equal to the existing service rank.

15. A system comprising:
a network comprising a plurality of computing devices to execute a set of executable instructions;
a listening set of executable instructions operating on each of the plurality of computing devices that receives an advertisement packet transmitted from each of the remaining plurality of computing devices, wherein the advertisement packet includes a service code identifying a type of computing device sending the advertisement packet and a network service rank of a network service offered by the sending computing device for use on the network, and wherein an existing network service is removed from the network when any received network service rank is greater than the existing network service rank; and
an advertising set of executable instructions operating on each of the plurality of computing devices that transmits the advertisement packet to each of the remaining plurality of computing devices.

16. The system of claim 15, wherein each advertising set of executable instructions transmits the advertisement packet at configurable periods of time to each of the remaining plurality of computing devices within the network.

17. The system of claim 15, wherein each listening set of executable instructions validates the received service code before inspecting the received network service rank, and wherein if the received service code is not validated the received advertisement packet is ignored.

18. The system of claim 15, wherein each listening set of executable instructions transmits to the sending computing device the existing network service rank when the existing network service rank is greater than the received network service rank.

19. The system of claim 15, wherein each listening set of executable instructions inspects a predefined communication port to identify the received advertisement packets.

20. An article comprising a machine-accessible medium having associated instructions, wherein the instructions, when accessed, result in a machine comprising at least one component performing:
periodically receiving by a receiving computing device an advertisement packet from a first computing device within a network, wherein the advertisement packet includes a network service rank associated with an offered network service and a service code identifying a type associated with the first computing device;
periodically transmitting from the receiving computing device an identifying packet to the first computing device and to one or more additional computing devices within the network, wherein the identifying packet includes an offered network service rank of an offered network service; and
periodically inspecting the received advertisement packet to determine if the service code is valid, and, if valid, to determine if the offered network service rank is greater than an existing network service rank of an existing network service and, if so, disabling the existing network service and installing the offered network service on the receiving computing device.

21. The article of claim 20, wherein the instructions, when accessed, additionally result in the machine performing:
calling a duplicate service set of executable instructions when the offered network service rank is equal to the existing network service rank, wherein the duplicate service set of executable instructions decides whether to disable the existing network service or to install the offered network service on the receiving computing device.

22. The article of claim 20, wherein the instructions, when accessed, additionally result in the machine performing:
configuring the receiving computing device before the offered network service is installed for operation on the receiving computing device.

23. The article of claim 21, wherein the instructions, when accessed, additionally result in the machine performing:
immediately transmitting the existing network service rank back to the first computing device, if the existing network service rank is greater than the offered network service rank.
